(19) United States
(12) Patent Application Publication
(10) Pub. No.: US 2018/0206008 A1
(43) Pub. Date: Jul. 19, 2018

(54) CONNECTION MANAGEMENT METHOD, CONTROLLER, AND SERVER CABINET

(71) Applicant: Lenovo (Beijing) Co., Ltd., Beijing (CN)

(72) Inventor: Bingxun SHI, Beijing (CN)

(21) Appl. No.: 15/863,097

(22) Filed: Jan. 5, 2018

(30) Foreign Application Priority Data
Jan. 17, 2017 (CN) 201710032933.2

(51) Int. Cl. H04Q 1/24; H04L 12/24

(52) U.S. Cl. CPC H04Q 1/24; H04Q 1/035; H04L 41/08

(57) ABSTRACT

A connection management method, a controller, and a server cabinet are provided The method comprises: sending a command to the switch to instruct the switch to send a signal to a designated port of the switch; receiving from a compute node connected to the designated port of the switch, a response to the signal received by the compute node from the designated port of the switch; and based on pre-acquired location information of the compute node, associating the pre-acquired location information of the compute node with the designated port of the switch.

### CROSS-REFERENCES TO RELATED APPLICATIONS

This application claims priority of Chinese Patent Application No. 201710032933.2, filed on Jan. 17, 2017, the entire contents of which are hereby incorporated by reference.

### FIELD OF THE INVENTION

The present disclosure generally relates to the field of servers and, more particularly, relates to a connection management method of a server cabinet.

### BACKGROUND

Currently, with the development of electronic devices, people's lives are getting more and more convenient, and services obtainable by people via the electronic devices are becoming diversified. Correspondingly, requirements on the computing capacity of the server are increased. As a result, a large number of compute nodes need to be connected in the server cabinet. Because the compute nodes are connected to various ports of a switch in the server cabinet via cables, when the number of the compute nodes is large, it can be hard to tell, through naked eyes, which cable is connected to a specific port of the switch and which compute node is connected to a specific port.

Accordingly, a highly effective and convenient solution is needed to allow the management personnel of the server cabinet to understand the cable connection in the server cabinet easily and quickly, thereby performing maintenance and monitoring of the server cabinet.

### BRIEF SUMMARY OF THE DISCLOSURE

One aspect of the present disclosure provides a method for managing connection between a plurality of compute nodes and a plurality of ports of a switch. The method comprises: sending, a command to the switch to instruct the switch to send a signal to a designated port of the switch; receiving from a compute node connected to the designated port of the switch, a response to the signal received by the compute node from the designated port of the switch; and based on pre-acquired location information of the compute node, associating the pre-acquired location information of the compute node with the designated port of the switch.

Another aspect of the present disclosure provides a controller for managing connection between a plurality of compute nodes and a plurality of ports of a switch. The controller comprises a processor, and a memory for storing a machine-executable instruction. When the instruction is executed by the processor, the processor executes following operations: sending a command to the switch for instructing the switch to send a signal to a designated port of the switch; receiving, from a compute node connected to the designated port of the switch, a response to the signal received from the designated port of the switch; and based on pre-acquired location information of the compute node, associating the pre-acquired location information of the compute node with the designated port of the switch.

Another aspect of the present disclosure provides a server cabinet comprising: a switch including a plurality of ports, at least one compute node respectively connected to different ports of the switch, and a controller connected to the switch and the at least one compute node. The controller is operative to send a command to the switch that instructs the switch to send a signal to a designated port of the switch. The switch is operative to, upon receiving the command from the controller, send the signal to the designated port. A compute node is operative, upon receiving the signal from the switch, to send a response to the signal to the controller of the switch. The controller is further operative, based on pre-acquired location information of the compute node, to associate the pre-acquired location information of the compute node with the designated port of the switch.

Other aspects of the present disclosure can be understood by those skilled in the art in light of the description, the claims, and the drawings of the present disclosure.

### BRIEF DESCRIPTION OF THE DRAWINGS

In order to more clearly illustrate technical solutions in embodiments of the present disclosure, drawings for the description of the embodiments are briefly introduced below. Obviously, the drawings described hereinafter are only some embodiments of the present disclosure, and it is possible for those ordinarily skilled in the art to derive other drawings from the following drawings without creative effort.

FIG. 1 illustrates an existing server cabinet;

FIG. 2 illustrates a simplified schematic view of an existing server cabinet;

FIG. 3 illustrates a block diagram of a server cabinet consistent with disclosed embodiments;

FIG. 4 illustrates a flow chart of a connection management method consistent with disclosed embodiments; and

FIG. 5 illustrates a block diagram of a controller for executing a method described in FIG. 4 consistent with disclosed embodiments.

### DETAILED DESCRIPTION

Based on detailed descriptions of embodiments in the present disclosure and with reference to the accompanying drawings, other aspects, advantages, and features of the present disclosure will become obvious to those skilled in the relevant art.

In the present disclosure, the terms “comprise”, “comprising”, or any other variation thereof are intended to cover a non-exclusive inclusion, and the term “or” is inclusive, meaning both or either.

In the specification, various embodiments provided hereinafter for describing principles of the present disclosure are for illustrative purposes only, and shall not be construed as limiting the present disclosure. With reference to the accompanying drawings, the following descriptions are provided to aid thorough understanding of the exemplary embodiments in the present disclosure defined by the appended claims and their equivalents.

The following descriptions may include various specific details to aid the understanding, and such details are for illustrative purposes only. Thus, those ordinarily skilled in the relevant art shall realize that, without departing from the scope and spirit of the present disclosure, various alterations and modifications can be made to embodiments described in this paper. Further, for clarity and concision, descriptions of well-known functions and structures are omitted. Additionally, throughout the accompanying drawings, the same reference numerals are applied for similar functions and operations.

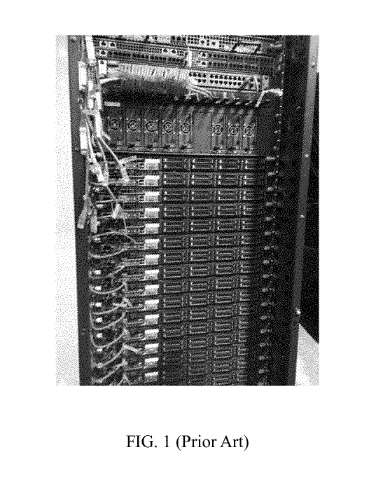

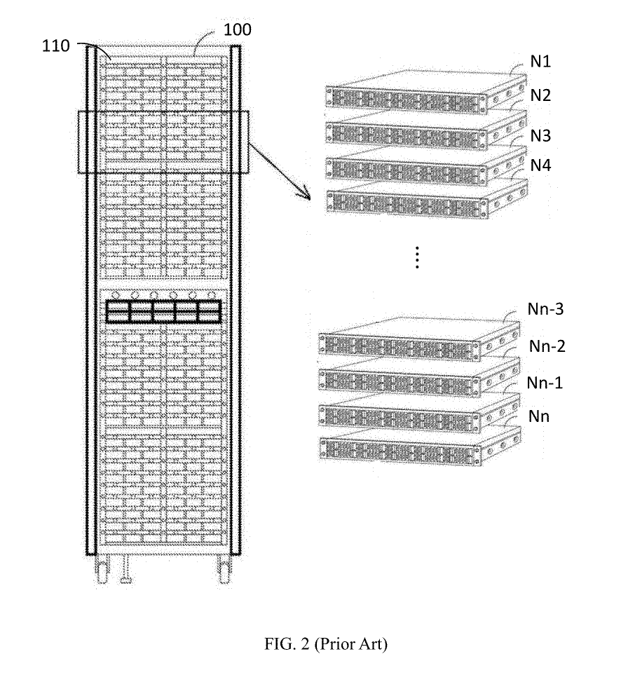

FIG. 1 illustrates an existing server cabinet. FIG. 2 illustrates a simplified schematic view of an existing server cabinet. As shown in FIG. 1 and FIG. 2, a large number of compute nodes N1˜Nn are placed in a server cabinet 100, where N is a positive integer, and the compute nodes N1˜Nn may be placed in a layer-by-layer manner. Each of the compute nodes is connected to a switch 110 placed on an upper layer of the server cabinet 100, and the computer nodes may exchange data via the switch 110.

The layered structure of the server cabinet 100 is to reduce the space occupied by the large number of the compute nodes and other network devices. Further, other than the compute nodes, various other network devices (e.g., memory driver, router, hardware firewall, and power source, etc.) may be installed in the server cabinet 100. However, in the existing server cabinet, the specific cable that connects a designated compute node to a designated port of the switch can hardly be identified through naked eyes.

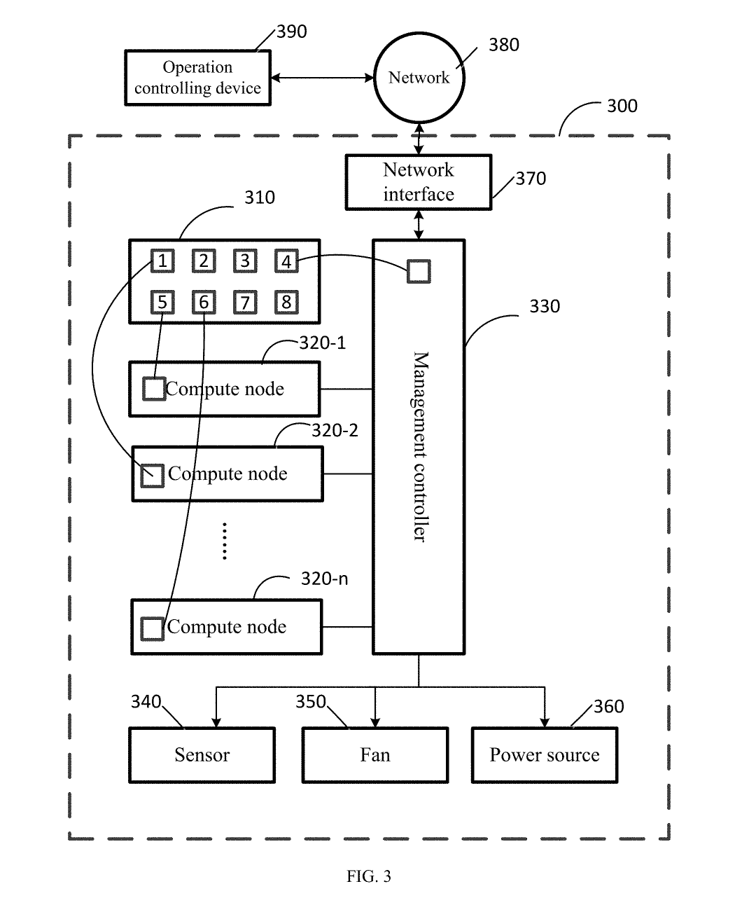

The present disclosure provides an improved server cabinet to at least partially solve the aforementioned issue. FIG. 3 illustrates a block diagram of a server cabinet consistent with disclosed embodiments. As shown in FIG. 3, a server cabinet 300 may include a switch 310, a plurality of compute nodes 320-1˜320-n, and a management controller 330. The switch 310 may further comprise a plurality of ports, for example, the switch 310 may include port 1˜port 8. Optionally, the server cabinet 300 may further include a sensor 340, a fan 350, and a power source 360. Optionally, the management controller 330 may be further connected to an external operation controlling device 390 via a network interface 370 and a network 380, and the network interface 370 may be included in the server cabinet 300.

More specifically, the plurality of compute nodes 320-1˜320-n may be connected to different ports of the switch 310, and when the compute nodes do not need to be differentiated, the plurality of compute nodes 320-1˜320-n may each be referred to as a compute node 320. The management controller 330 may be connected to a port of the switch 310, and the port of the switch 310 connected to the management controller 330 does not simultaneously connect to any of the computer nodes. Further, the management controller 330 may be connected to each of the compute nodes 320-1˜320-n.

Optionally, the aforementioned compute node may be a server, a dual-server, etc., for running a task. Further, the management controller 330 may be a rack management controller (RMC) configured to manage various functions of the server cabinet, including but not limited to functions such as fan control, power management, sensor management, and/or remote control via a network. The management controller 330 may be connected to the switch 310 via a cable. In some embodiments, the server cabinet 300 may further include a backplane, and the management controller 330 may be connected to each compute node via the backplane of the server cabinet 300. In some other embodiments, the management controller 330 may be connected to each compute node via an inter-integrated circuit (I²C) cable.

In one example, as shown in FIG. 3, the compute node 320-1 may be connected to a port 5 of the switch 310, a compute node 320-2 may be connected to a port 1 of the switch 310, the compute node 320-n may be connected to a port 6 of the switch 310, and the management controller 330 may be connected to a port 4 of the switch 310. Though in FIG. 3, the switch 310 is illustrated to comprise 8 ports (i.e., port 1, port 2, . . . , port 8), those skilled in the relevant art may realize that the number of the ports in the switch 310 is not limited to 8.

Further, the connections between the compute nodes 320 and the switch 310, and the connection between the management controller 330 and the switch 310 are not limited to situations illustrated in FIG. 3. When the number of compute nodes 320 is very large (i.e., n is very large), the cables connected to the switch 310 can be rather complicated. Thus, the management personnel can hardly recognize the topological structure of connections between the compute nodes 320 and the switch 310 manually or through cables. Directed towards such issue, a method for managing connections regarding a large number of compute nodes will be provided later in this specification.

Optionally, the sensor 340 may be provided for sensing the environmental condition of the server cabinet 300. For example, the sensor 340 may be a temperature sensor, and the temperature sensor may be operative for sensing the temperature of the server cabinet. Or, the sensor 340 may be a vibration sensor, and the vibration sensor may be operative for sensing the stability of the server cabinet. The fan 350 may be provided for cooling purposes when the temperature of the server cabinet is relatively high. The power source 360 may be provided for charging each compute node and other elements in the server cabinet.

Further, the management controller 330 may monitor the condition of each compute node (320-1, 320-2, . . . , or 320-n) and control the on-and-off of the power source 360 that charges the compute nodes. Further, by monitoring the temperature sensor of the server cabinet 300, the management controller 330 may control the speed of the fan 350 and/or the on-and-off of the fan 350.

In one embodiment, when the management controller 330 is further connected to an external operation controlling device 390 via a network interface 370 and a network 380, the management personnel may control the server cabinet 300 via the operation controlling device 390. For example, the management controller 330 may report the status, system log, or error information of each component in the server cabinet 300 to the operation controlling device 390. Further, the management controller 330 may further receive a command sent by the management personnel via the operation controlling device 390.

The command may be, for example, a command for changing the speed of the fan 350, or a command for turning on/off the power source 360 that charges a certain component. The network 380 may be a wired network or a wireless network. For example, the network 380 may be a local area network (LAN), a wireless local area network (WLAN), a wide area network (WAN, such as an internet), and Ethernet, etc. Accordingly, the compute nodes in the server cabinet 300 may exchange data with the external side via the network.

In some embodiments, the management controller 330 may use an intelligent platform management interface (IPMI) protocol to communicate with the server cabinet 300, where the IPMI is a group of criterions for managing a computer system. Such criterions are provided to manage and monitor the central processing unit (CPU), the firmware, and the operating system of the computer system, and a plurality of administrators may perform out-of-management and monitoring of the system. The management controller 330 may use any bus interface for connection to components in the server cabinet 300. The bus interface may be, for example, a system management bus interface, a RS-232 serial interface, an I²C protocol interface, an Ethernet interface, or an IPMI protocol bus interface. The feature of the I²C protocol lies in the adoption of a multi-master, multi-slave, serial single-ended computer bus line that comprises a serial data line (SDL) and a serial clock line (SCL) in either a 7-bit or 10-bit address space.

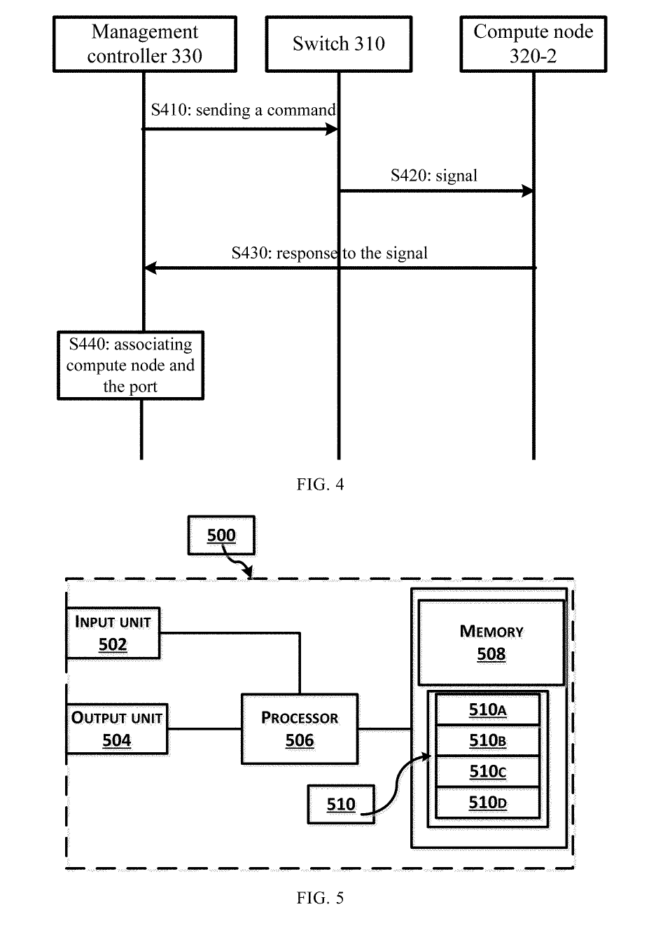

FIG. 4 illustrates a flow chart of a connection management method consistent with disclosed embodiments. As shown in FIG. 4, the connection management method may include steps S410˜S440. In one embodiment, the connection management method disclosed in FIG. 4 may be applied to the server cabinet 300 illustrated in FIG. 3, and the connection management method may be provided for managing connections between the compute nodes and different ports of the switch 310. More specifically, in step S410, the management controller 330 may send a command to the switch 310 for instructing the switch 310 to send a signal to a designated port thereof (e.g., the port 1 as illustrated in FIG. 4).

In step S420, upon receiving the command from the management controller 330, the switch 310 may send the signal to the designated port (e.g., the port 1).

In step S430, upon receiving the signal from the designated port of the switch 310, the compute node may send a response to the signal to the management controller 330. For example, the compute nodes 320-2 connected to the port 1 of the switch 310 may receive a signal from the port 1 and further send a response to the signal to the management controller 330.

In step S440, the management controller 330 may, based on pre-acquired location information of the compute node, associate the location information of the compute node (e.g., the compute node 320-2) with the designated port (e.g., the port 1). The location information of a compute node may refer to a physical location of the compute node, or an IP address of the compute node, etc.

In some embodiments, the management controller 330 may pre-acquire a physical location of each compute node. For example, the server cabinet 300 may have a layered structure, the plurality of compute nodes 320-1˜320-n may be placed in a layer-by-layer manner in the server cabinet 300, and the management controller 330 may pre-acquire the specific layer that each compute node is located on. Given the compute node 320-2 as an example, the management controller 330 may pre-acquire that the compute node 320-2 is located on an m^{th} layer of the server cabinet 300.

Further, the management controller 330 may associate the location information of each compute node (i.e., the specific layer that each computer node is located on) with a corresponding port. For example, the switch 310 may send a signal to the port 1 based on the command sent by the management controller 330, and the compute node 320-2 may receive the signal from port 1 of the switch and send a response to the signal to the management controller 330. Thus, the management controller 330 may understand that the compute node 320-2 is connected to the port 1 of the switch 310 and, because the location information of the compute node 320-2 is pre-acquired to be the m^{th} layer of the server cabinet 300, the management controller 330 may further associate the location information of the compute node 320-2 (i.e., m^{th} layer) with the port 1 of the switch 310.

In some embodiments, the management controller 330 may pre-acquire IP addresses of the compute nodes. Optionally, the management controller 330 may acquire an IP address of a compute node through other communication with the compute node. In one example, the management controller 330 may pre-acquire the IP address of the compute node 320-2 to be 192.168.2.11, and the IP address of the compute node 320-2 may be associated with the physical location of the compute node 320-2 and the corresponding port in the switch 310.

That is, the compute node 320-2 on the m^{th} layer may be determined to be connected to the port 1 of the switch 310, and the IP address of the compute node 320-2 is pre-determined to be 192.168.2.11. Thus, after the management controller 330 instructs the switch 310 to send a signal to the port 1 and receives the response to the signal from the compute node 320-2 with an IP address of 192.168.2.11, the compute node 320-2 on the m^{th} layer with the IP address of 192.168.2.11 may be determined to be connected to the port 1 of the switch 310. Accordingly, the pre-acquired IP address of the compute node 320-2 is associated with the physical location thereof and the port 1 of the switch 310.

Optionally, in one embodiment, the IP addresses of the compute nodes do not need to be pre-acquired. For example, when the management controller 330 receives a response to the signal (that is sent by the switch 310 to a designated port) from a compute node, the IP address of the compute node may be determined based on the response. Further, the determined IP address may be associated with the physical location of the compute node, and a corresponding port of the switch 310, etc.

The management controller 330 may execute the aforementioned method repeatedly for all ports (except the port connected to the management controller 330) of the switch 310, thereby obtaining the association between the ports of the switch 310 and location information of the compute nodes connected to such ports. Further, the management controller 330 may, based on the association between each port of the switch 310 and location information of a corresponding compute node, determine a connection diagram of the ports of the switch 310.

For example, regarding the example illustrated in FIG. 3, the management controller 330 may depict a connection table for look-up and maintenance by the management personnel:

| | Location of compute node | |
|---|---|---|
| Port number | (layer number) | IP address of compute node |
| 1 | 1 | 192.168.2.10 |
| 5 | 2 | 192.168.2.11 |
| . . . | . . . | . . . |
| 6 | N | 192.168.2.18 |

By looking up the table, the management personnel may acquire the cable connection topology in the server cabinet directly and quickly, thereby performing further maintenance and monitoring of the server cabinet.

In some embodiments, the signal sent by the switch 310 to a compute node connected to a designated port of the switch 310 may be a specialized signal. When a compute node is configured to receive the specialized signal, the compute node may send a response to the specialized signal to the management controller 330, such as sending the specialized signal back to the management controller 330 in its original state. Further, when the management controller 330 receives such specialized signal, the specialized signal may be determined as the response to the specialized signal sent by the compute node, such that the aforementioned compute node is determined to be connected to the designated port.

In some embodiments, the signal sent by the switch 310 to a compute node that is connected to a designated port of the switch 310 may be loaded into other messages sent by the switch 310 to the compute node. For example, after receiving an instruction or command from the management controller 330, the switch 310 may add a port number to a message sent by the switch 310 to the designated port, and the compute node that receives the message from the designated port may send the port number that is loaded in the message to the management controller 330. The management controller 330 may thus determine the port connected to the compute node, and further associate the location information of the compute node with the port of the switch 310.

FIG. 5 illustrates a block diagram of a controller 500 that executes a method described in FIG. 4 consistent with the disclosed embodiments. As shown in FIG. 5, the controller 500 may include an input unit 502, an output unit 504, a processing unit or a processor 506, and a memory 508. The input unit 502 may be configured to receive a signal from other devices or components (e.g., a compute node or sensor connected thereto). The output unit 504 may provide a signal to other devices or components (e.g., a compute node, sensor, or switch connected thereto). The input unit 502 and the output unit 504 may be configured into an integral piece.

Further, the processor 506 may be a single unit or a combination of plural units, and may be configured to execute different steps of a method. The memory 508 may store an instruction 510 that instructs the controller 500 to execute steps of the method described in FIG. 4 when the processor 506 in the controller 500 operates. The instruction 510 may be configured to include a computer program code.

In one embodiment, the code in the instruction 510 of the controller 500 may include a sending module 510A, a receiving module 510B, an association module 510C, and a depiction module 510D. The sending module 510A may be provided for sending a command to the switch via the output unit that instructs the switch to send a signal to a designated port. The receiving module 510B may be provided for receiving a response sent by the compute node in response to the signal received from the switch from the compute node connected to the designated port of the switch via the input unit.

Further, the association module 510C may be provided for, based on pre-acquired location information of the compute node, associating the location information of the compute node with the designated port. The depiction module 510D may be provided for depicting a port connection diagram of the switch based on the association between each port of the switch and the location information of the corresponding compute node.

Based on embodiments of the present disclosure, the aforementioned method, device, unit and/or module may be implemented by using an electronic device having the computing capacity to execute software that comprises computer instructions. Such system may include a storage device for implementing various storage manners mentioned in the foregoing descriptions. The electronic device having the computing capability may include a device capable of executing computer instructions, such as a general-purpose processor, a digital signal processor, a specialized processor, a reconfigurable processor, etc., and the present disclosure is not limited thereto. Execution of such instructions may allow the electronic device to be configured to execute the aforementioned operations of the present disclosure. The above-described device and/or module may be realized in one electronic device, or may be implemented in different electronic devices. Such software may be stored in a computer readable storage medium. The computer storage medium may store one or more programs (software modules), the one or more programs may comprise instructions, and when the one or more processors in the electronic device execute the instructions, the instructions enable the electronic device to execute the disclosed method.

Such software may be stored in forms of volatile memory or non-volatile memory (e.g., storage device similar as ROM), no matter whether it is erasable or overridable, or may be stored in the form of memory (e.g., RAM, memory chip, device or integrated circuit), or may be stored in optical readable media or magnetic readable media (e.g., CD, DVD, magnetic disc, or magnetic tape, etc.). It should be noted that, the storage device and storage media are applicable to machine-readable storage device embodiments storing one or more programs, and the one or more programs comprise instructions. When such instructions are executed, embodiments of the present disclosure are realized. Further, the disclosed embodiments provide programs and machine-readable storage devices storing the programs, and the programs include codes configured to realize the device or method described in any of the disclosed claims. Further, such programs may be electrically delivered via any medium (e.g., communication signal carried by wired connection or wireless connection), and various embodiments may appropriately include such programs.

The method, device, unit and/or module according to the embodiments of the present disclosure may further use a field-programmable gate array (FPGA), programmable logic array (PLA), system on chip (SOC), system on the substrate, system on encapsulation, application-specific integrated circuit (ASIC), or may be implemented using hardware or firmware configured to integrate or encapsulate the circuit in any other appropriate manner, or may be implemented in an appropriate combination of the three implementation manners of software, hardware, and firmware. Such system may include a storage device to realize the aforementioned storage. When implemented in such manners, the applied software, hardware, and/or firmware may be programmed or designed to execute the corresponding method, step, and/or function according to the present disclosure. Those skilled in the relevant art may implement one or more, or a part or multiple parts of the systems and modules by using different implementation manners appropriately based on actual demands. Such implementation manners shall all fall within the protection scope of the present disclosure.

Though the present disclosure is illustrated and described with reference to specific exemplary embodiment of the present disclosure, those skilled in the relevant art should understand that, without departing from appended claims and the spirit and scope of the present disclosure defined equivalently, various changes may be made to the present disclosure in the manner and detail. Therefore, the scope of the present disclosure shall not be limited to the aforementioned embodiments, but shall not be only determined by the appended claims, but may be further defined by equivalents of the appended claims.

What is claimed is:

1. A method for managing connection between a plurality of compute nodes and a plurality of ports of a switch, the method comprising:
sending a command to the switch to instruct the switch to send a signal to a designated port of the switch;
receiving from a compute node connected to the designated port of the switch, a response to the signal received by the compute node from the designated port of the switch; and
based on pre-acquired location information of the compute node, associating the pre-acquired location information of the compute node with the designated port of the switch.

2. The method according to claim 1, further comprising:
associating an IP address of the compute node with the location information of the compute node.

3. The method according to claim 2, wherein:
the IP address is pre-acquired.

4. The method according to claim 1, further comprising:
connecting the compute node to a controller via an inter-integrated circuit (I²C cable),
wherein the signal is a specialized signal.

5. The method according to claim 1, wherein the method is repeatedly executed for the plurality of ports of the switch to obtain association between the plurality of ports of the switch and location information of the plurality of compute nodes connected to the plurality of ports of the switch.

6. The method according to claim 5, further comprising:
based on the association between the plurality of ports of the switch and location information of the plurality of compute nodes, providing a connection diagram showing the association between the plurality of ports of the switch and the plurality of compute nodes.

7. A controller for managing connection between a plurality of compute nodes and a plurality of ports of a switch, comprising:
a processor; and
a memory for storing a machine-executable instruction, wherein when the instruction is executed by the processor, the processor executes following operations:
sending a command to the switch for instructing the switch to send a signal to a designated port of the switch;
receiving, from a compute node connected to the designated port of the switch, a response to the signal received from the designated port of the switch; and
based on pre-acquired location information of the compute node, associating the pre-acquired location information of the compute node with the designated port of the switch.

8. The controller according to claim 7, wherein the memory further stores an instruction that enables the processor to execute a following operation:
associating an IP address of the compute node with the location information of the compute node.

9. The controller according to claim 8, wherein:
the IP address is a pre-acquired IP address.

10. The controller according to claim 7, wherein:
the controller is a rack management controller (RMC).

11. The controller according to claim 10, wherein:
the compute node is connected to the RMC via an inter-integrated circuit (I²C cable), and
the signal is a specialized signal.

12. The controller according to claim 7, wherein the memory further stores an instruction that enables the processor to execute a following operation:
based on association between the plurality of ports of the switch and location information of the plurality of compute nodes, providing a connection diagram showing the association between the plurality of ports of the switch and the plurality of compute nodes.

13. A server cabinet, comprising:
a switch including a plurality of ports;
at least one compute node respectively connected to different ports of the switch; and
a controller connected to the switch and the at least one compute node,
wherein the controller is operative to send a command to the switch that instructs the switch to send a signal to a designated port of the switch,
the switch is operative, upon receiving the command from the controller, to send the signal to the designated port of the switch,
the compute node is operative, upon receiving the signal from the switch, to send a response to the signal to the controller, and
the controller is further operative, based on pre-acquired location information of the compute node, to associate the pre-acquired location information of the compute node with the designated port of the switch.

14. The server cabinet according to claim 13, wherein:
the controller is a rack management controller (RMC).

15. The server cabinet according to claim 14, wherein:
the compute node is connected to the RMC via an inter-integrated circuit (I²C cable).

16. The server cabinet according to claim 13, further comprising:
a sensor configured to sense an environmental condition of the server cabinet;
a fan configured to cool the server cabinet if a temperature of the server cabinet is relatively high; and
a power source configured to charge the at least one compute node.

17. The server cabinet according to claim 13, wherein:
the controller is further operative to perform sensor management, fan control, and power management.

18. The server cabinet according to claim 10, wherein:
the controller is further connected to a network via a network interface, and
the controller is adaptable to allow remote control via the network.
